(19) United States
(12) Patent Application Publication
(10) Pub. No.: US 2025/0316932 A1
(43) Pub. Date: Oct. 9, 2025

(54) CONNECTOR STRUCTURE

(71) Applicant: YAZAKI CORPORATION, Tokyo (JP)

(72) Inventors: Kei Sato, Makinohara-shi (JP); Dacheng Jin, Makinohara-shi (JP)

(21) Appl. No.: 19/072,958

(22) Filed: Mar. 6, 2025

(30) Foreign Application Priority Data
Apr. 8, 2024 (JP) 2024-062076

(51) Int. Cl. H01R 13/6592

(52) U.S. Cl. CPC H01R 13/6592

(57) ABSTRACT

A connector structure includes a cable, an inner sleeve, a pair of inner terminals, an inner housing, a matching component in which a pair of hollow accommodating portions configured to accommodate end portions of a twisted pair electric wire connected to the inner terminals in a predetermined arrangement form are elastically deformable in an electric wire radial direction of the twisted pair electric wire, and an outer terminal including a shield body configured to cover an outer periphery of the inner housing, and a crimping portion that extends from the shield body and that is crimped to an outer peripheral side of the inner sleeve so as to be electrically connected to an end portion of a braid folded back and placed over the outer peripheral side of the inner sleeve.

### CROSS-REFERENCE TO RELATED APPLICATIONS

This application is based on and claims priority under 35 USC 119 from Japanese Patent Application No. 2024-062076 filed on Apr. 8, 2024, the entire content of which is incorporated herein by reference.

### TECHNICAL FIELD

The present disclosure relates to a connector structure of a shielded connector.

### BACKGROUND ART

In recent years, twisted pair cables (twisted pair electric wires) are preferably used for an in-vehicle network and the like, as the twisted pair cables are less likely to be affected by noise than simple parallel wires and have less noise radiation.

A shielded connector that is connected to the end of this twisted pair cable includes an inner terminal that is connected to the ends of two twisted electric wires of a shielded twisted pair (STP) cable, an inner housing that accommodates the inner terminal, and an outer terminal that encloses the inner housing.

As a connector structure for improving the transmission characteristic of such a shielded connector, for example, a connector structure disclosed in JP2019-164997A is known.

The connector structure includes a connector and a cable that is connected to the connector, and the connector and the cable include at least one conductor pair (twisted pair electric wires) including a first conductor and a second conductor. The connector structure further includes a first portion on the cable, a second portion on the connector side, and an intermediate portion that is formed between the first portion and the second portion.

The conductor pair is surrounded by an outer conductor (an outer terminal) at the first portion, the second portion, and the intermediate portion, and the outer conductor has a deformation in a part of the intermediate portion surrounding the conductor pair, the deformation reducing at least one of the distance between the outer conductor and the conductors or the distance between the conductors in the deformed region.

Therefore, by deforming the outer conductor to change the distance between the outer conductor and the conductors, or the distance between the conductors of the conductor pair, the connector structure can be improved for different characteristics.

In the connector structure in the related art described above, a new external force or the like is applied to the outer conductor in the intermediate portion to cause deformation and reduce the distance between the conductors of the conductor pair. However, there are problems in that it is difficult to adjust the amount of deformation in the outer conductor and equipment is required to cause deformation.

The present disclosure provides a connector structure that can easily improve the transmission characteristics in a shielded connector using twisted pair electric wires.

### SUMMARY

The object of the present disclosure described above is implemented by the following configuration.

A connector structure includes a cable in which a braid surrounding a twisted pair electric wire is covered with a sheath, an inner sleeve that is placed over an outer peripheral side of the braid exposed from an end portion of the sheath, a pair of inner terminals that are electrically connected to core wires of the twisted pair electric wire exposed from the end portion of the sheath, an inner housing in which the inner terminals are each accommodated in a respective one of a pair of inner terminal accommodating portions, a matching component in which a pair of hollow accommodating portions configured to accommodate end portions of the twisted pair electric wire connected to the inner terminals in a predetermined arrangement form are elastically deformable in an electric wire radial direction of the twisted pair electric wire, and an outer terminal including a shield body configured to cover an outer periphery of the inner housing, and a crimping portion that extends from the shield body and that is crimped to an outer peripheral side of the inner sleeve so as to be electrically connected to an end portion of the braid folded back and placed over the outer peripheral side of the inner sleeve.

According to the connector structure in the present disclosure, it is possible to easily improve the transmission characteristic in a shielded connector using twisted pair electric wires.

The present disclosure has been briefly described above. Further, the details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a perspective view of a shielded connector showing a state before an inner module having a connector structure according to a first embodiment of the present disclosure is accommodated in an outer housing;

FIG. 2 is an exploded perspective view of the inner module shown in FIG. 1;

FIG. 3 is an enlarged perspective view of a matching component shown in FIG. 2;

FIG. 4 is an enlarged perspective view of the matching component shown in FIG. 3 as viewed from the rear;

FIG. 5 is a cross-sectional view taken along a line V-V in FIG. 3;

FIG. 6 is a cross-sectional view taken along a line VI-VI in FIG. 3;

FIG. 7 is an explanatory view showing the procedure for connecting the inner module to the end of a cable, and shows a state in which an inner sleeve is placed over the outer periphery of a braid exposed by cutting off a part of a sheath at the end of the cable;

FIG. 8 is an explanatory view showing the procedure for connecting the inner module to the end of the cable, and shows a state in which the inner terminal is electrically connected to the core wire of a twisted pair electric wire exposed from the end portion of the sheath;

FIG. 9 is an explanatory view showing the procedure for connecting the inner module to the end of the cable, and shows a state in which the inner terminal is inserted through the matching component;

FIG. 10 is a cross-sectional view taken along a line X-X in FIG. 9;

FIG. 11 is an explanatory view showing the procedure for connecting the inner module to the end of the cable, and shows a state in which the inner terminal inserted through the matching component is accommodated in an inner terminal accommodating portion of an inner housing;

FIG. 12 is a cross-sectional view taken along a line XII-XII in FIG. 1;

FIG. 13 is a cross-sectional view taken along a line XIII-XIII in FIG. 12;

FIG. 14 is an explanatory view showing a procedure for connecting an inner module having a connector structure according to a second embodiment of the present disclosure to the end of a cable, and shows a state in which an inner terminal inserted through a matching component is accommodated in an inner terminal accommodating portion of the inner housing;

FIG. 15 is a longitudinal cross-sectional view showing a state in which an outer terminal is crimped to the end of the cable in the inner module shown in FIG. 14;

FIG. 16 is a cross-sectional view taken along a line XVI-XVI in FIG. 14;

FIG. 17 is a cross-sectional view taken along a line XVII-XVII in FIG. 15;

FIGS. 18A to 18D are plan views showing a modification of the matching component;

FIG. 19 is an exploded perspective view of an inner module having a connector structure according to a third embodiment of the present disclosure;

FIG. 20 is a cross-sectional view taken along a line XX-XX in FIG. 19, showing a state in which the inner module shown in FIG. 19 is connected to the end of a cable;

FIG. 21 is a cross-sectional view taken along a line XXI-XXI in FIG. 20;

FIG. 22 is an exploded perspective view of an inner module having a connector structure according to a fourth embodiment of the present disclosure;

FIG. 23 is an enlarged perspective view of a matching component shown in FIG. 22;

FIG. 24 is a cross-sectional view taken along a line XXIV-XXIV in FIG. 22, showing a state in which the inner module shown in FIG. 22 is connected to the end of a cable; and

FIG. 25 is a cross-sectional view taken along a line XXV-XXV in FIG. 23.

### DESCRIPTION OF EMBODIMENTS

Hereinafter, embodiments of the present disclosure will be described with reference to the drawings.

### First Embodiment

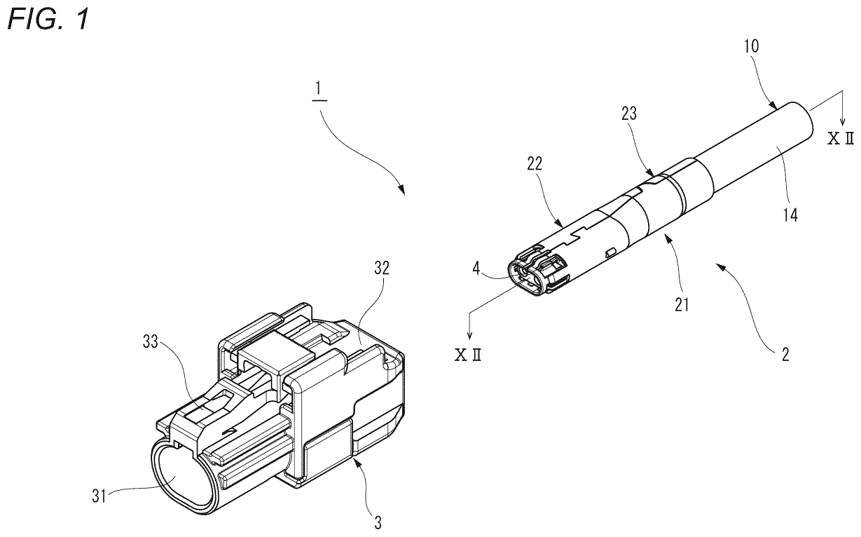

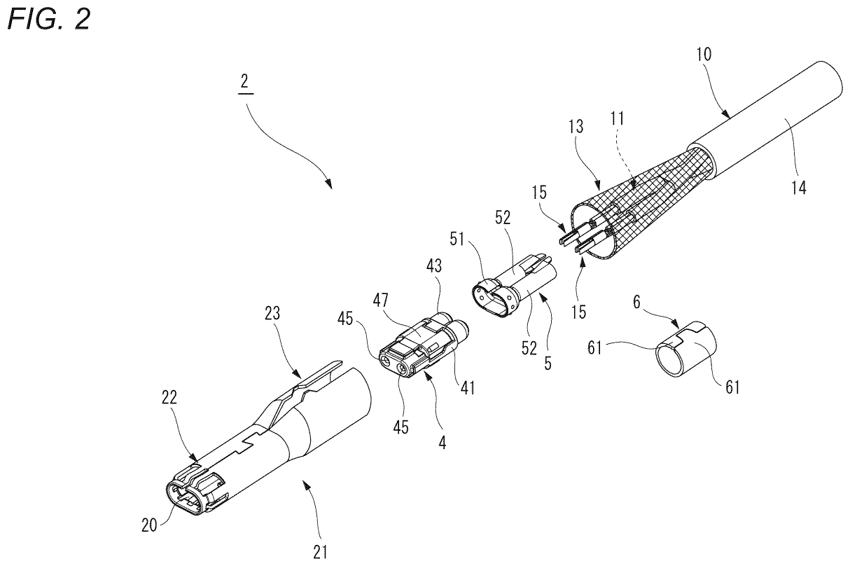

FIG. 1 is a perspective view of a shielded connector 1 showing a state before an inner module 2 having a connector structure according to a first embodiment of the present disclosure is accommodated in an outer housing 3. FIG. 2 is an exploded perspective view of the inner module 2 shown in FIG. 1.

As shown in FIG. 1, the shielded connector 1 having the connector structure according to the first embodiment is for high-speed transmission, and includes the inner module 2 that is connected to the end of a shielded electric wire 10, and the outer housing 3 in which the inner module 2 is accommodated. The shielded electric wire 10 is a shielded twisted pair (STP) cable in which a braid 13 surrounding twisted pair electric wires 11 is covered with a sheath 14.

The outer housing 3 is made of insulating resin and has a box shape, and has a module accommodating portion 31 in which the inner module 2 is accommodated. On an upper face 32 side of the outer housing 3, a lock arm 33 is provided for maintaining a fitted state when fitted to a mating connector (not shown).

As shown in FIGS. 1 and 2, the inner module 2 includes the shielded electric wire 10, an inner terminal 15, an inner housing 4, a matching component 5, an inner sleeve 6, and an outer terminal 21.

The shielded electric wire 10 includes the twisted pair electric wires 11 in which two electric wires are twisted, the braid 13 that covers the twisted pair electric wire 11 via a metal foil 12, and the sheath 14 that is made of insulating resin and that covers the braid 13.

Each electric wire of the twisted pair electric wires 11 includes a core wire 11a, and a resin insulating sheath 11b that covers the core wire 11a (see FIG. 8). The twisted pair electric wires 11 that are exposed on the end side of the shielded electric wire 10 is untwisted, and the inner terminal 15 is crimped and connected to the core wire 11a that is exposed from the insulating sheath 11b at each end.

After the inner sleeve 6 is crimped to the outer peripheral side as described later, the braid 13 that is exposed on the end side of the shielded electric wire 10 is folded back to the outer peripheral side from the distal end edge of the inner sleeve 6, and a folded back portion 13a is folded back to the outside of the sheath 14.

The inner housing 4 includes a housing body 41 that is formed into an elliptical columnar shape from insulating resin, and includes, on both sides thereof, a pair of inner terminal accommodating portions 45 and 45 that accommodate the inner terminal 15 crimped and connected to the core wire 11a of the shielded electric wire 10. The inner terminal 15 is inserted from the rear end opening of the inner housing 4, and is accommodated in the inner terminal accommodating portion 45.

In the inner housing 4, a retainer 47 for retaining and locking the inner terminal 15 accommodated in the inner terminal accommodating portion 45 is provided on a part of the upper wall of the housing body 41.

The retainer 47 is integrally molded with the housing body 41 via a thin hinge, and can be opened and closed relative to an opening communicating with the inner terminal accommodating portion 45. A locking protrusion (not shown) protruding from the inner surface of the retainer 47 locks the inner terminal 15 accommodated in the inner terminal accommodating portion 45, so that the inner terminal 15 can be prevented from coming off the inner housing 4.

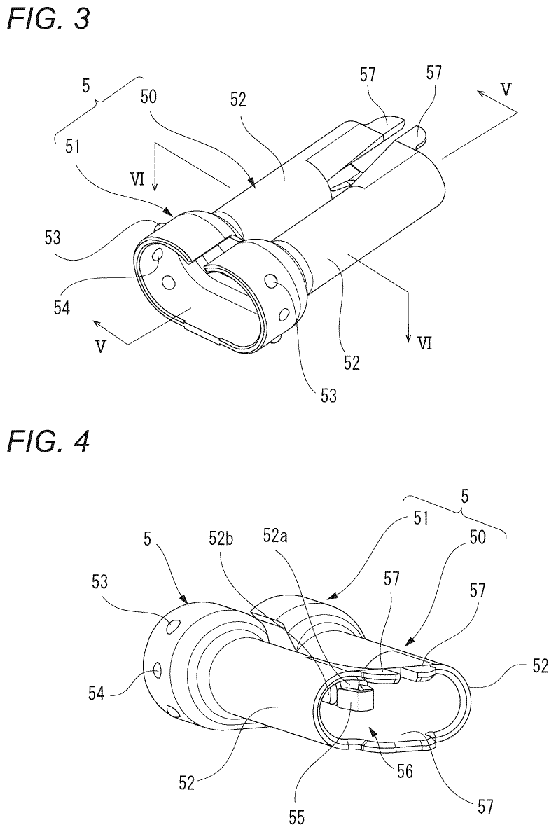

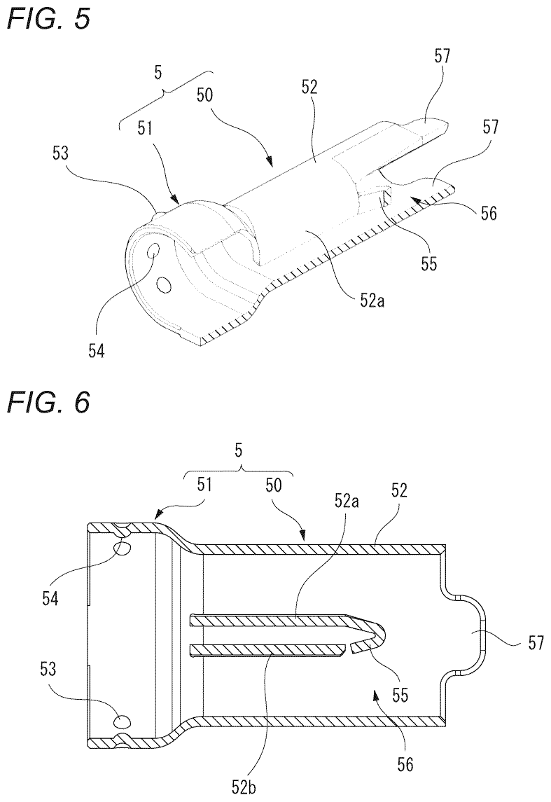

As shown in FIGS. 3 to 6, the matching component 5 according to the first embodiment is made of metal and formed into a substantially elliptical cylindrical shape, and includes a transmission characteristic ensuring portion 50 that improves the transmission performance of the inner module 2, and a housing connection portion 51 that is externally fitted to a rear end portion 43 of the inner housing 4.

The transmission characteristic ensuring portion 50 includes a pair of hollow resilient accommodating portions 52 and 52, and can individually accommodate each of the untwisted electric wires at the ends of the twisted pair electric wires 11. The accommodating portion 52 is press-molded so as to inwardly roll both side edge portions 52a and 52b of the matching component 5 along the electric wire insertion direction, thereby defining a hollow space having a circular cross section.

That is, the transmission characteristic ensuring portion 50 is implemented such that the pair of hollow accommodating portions 52 and 52 accommodating the end portions of the twisted pair electric wires 11 connected to the inner terminal 15 in a predetermined arrangement form can be elastically deformed in the electric wire radial direction of the twisted pair electric wires 11.

The accommodating portion 52 has an inner diameter that is approximately equal to the diameter of each electric wire of the twisted pair electric wires 11, and is set to a dimension such that each electric wire comes into contact with the accommodating portion or there is a slight gap therebetween. The dimension is set by ordinary press molding, and no special equipment such as a crimping machine is required for assembly.

That is, since the accommodating portion 52 can be deformed along each electric wire of the twisted pair electric wires 11, it is possible to reduce the gap between each electric wire and the inner peripheral wall of the accommodating portion 52. Therefore, there is no adverse influence such as deterioration of the transmission characteristic of the electric wire. Further, the gap between each electric wire and the inner peripheral wall of the accommodating portion 52 is small, so that the electric wire is less likely to be damaged.

Since the hollow shape of the accommodating portion 52 is press-formed for each electric wire of the twisted pair electric wires 11, the shape can accommodate pitch conversion even when the pair wire pitch of the twisted pair electric wires 11 differs from the housing pitch, which is the interval between the pair of inner terminal accommodating portions 45 and 45 in the inner housing 4.

Further, when the end portions of the twisted pair electric wires 11 connected to the inner terminal 15 are inserted through the accommodating portion 52, the resilient accommodating portion 52 elastically deforms in the electric wire radial direction and elastically returns to the original shape thereof after the insertion, making the insertion operation easy.

Since the pair wire pitch of the twisted pair electric wires 11 differs from the housing pitch, which is the interval between the pair of inner terminal accommodating portions 45 and 45 in the inner housing 4, a pitch converting portion 56 for adjusting the pitch is provided on the rear end side of the accommodating portion 52.

The pitch converting portion 56 is formed at the rear end portions of both side edge portions 52a and 52b of the matching component 5 that are press-molded so as to be rolled inward in order to define the accommodating portion 52.

The pitch converting portion 56 includes the pair of side edge portions 52a and 52b that are arranged in parallel with a predetermined width direction interval, and a branching guide portion 55 that is formed by bending a protruding piece formed at the rear end portion of the side edge portion 52a into a V shape in cross section.

When the end portions of the twisted pair electric wires 11 connected to the inner terminal 15 are inserted from the rear opening of the transmission characteristic ensuring portion 50, the branching guide portion 55 inserts and guides each of the end portions of the twisted pair electric wires 11 into a respective one of the pair of hollow accommodating portions 52 and 52. Therefore, each of the end portions of the twisted pair electric wires 11 is inserted through a respective one of the accommodating portions 52 and 52, and the pair wire pitch of the twisted pair electric wires 11 is smoothly converted to the housing pitch.

The housing connection portion 51 has a wider opening shape than the transmission characteristic ensuring portion 50 so as to be externally fitted to the rear end portion 43 of the inner housing 4. On the outer side of the housing connection portion 51, a plurality of outer protrusions 53 that function as an electrical connection between the matching component 5 and the outer terminal 21 are arranged in a semi-spherical shape. On the inner side of the housing connection portion 51, a plurality of inner protrusions 54 that have a loose mechanical locking function for the rear end portion 43 of the inner housing 4 are arranged in a semi-spherical shape.

The inner sleeve 6 is made of metal having conductivity, and includes a pair of crimping pieces 61 and 61 so as to have a U-shaped cross section. The inner sleeve 6 is a cylindrical crimping member that is placed over the outer peripheral side of the braid 13 exposed from the end portion of the sheath 14 and that is crimped and fixed.

The outer terminal 21 is made of metal having conductivity, and includes a shield body 22 that is formed into a substantially elliptical cylindrical shape, and a crimping portion 23 that increases in diameter from the rear end of the shield body 22 and that extends into a C-shaped cross section. An inner housing accommodating chamber 20 that accommodates the inner housing 4 is formed in the shield body 22. The crimping portion 23 having a C-shaped cross section is crimped into a cylindrical shape along the outer peripheral shape of the inner sleeve 6 so as to be electrically connected to the end portion of the braid 13 that is folded back and placed over the outer peripheral side of the inner sleeve 6.

Next, the procedure for assembling the inner module 2 of the shielded connector described above will be described.

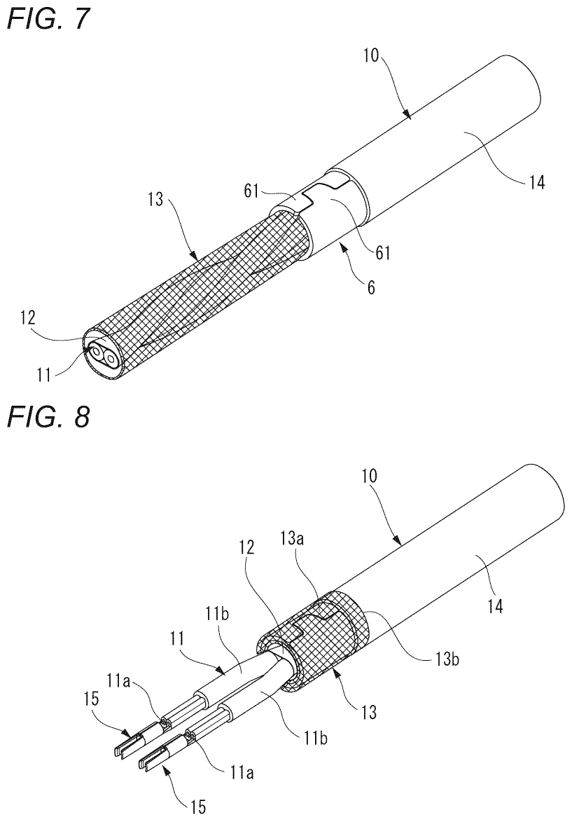

FIGS. 7 to 11 are explanatory views showing the procedure for connecting the inner module 2 to the end of the shielded electric wire (cable) 10.

First, as shown in FIG. 7, the inner sleeve 6 is crimped so as to be placed over the outer periphery of the braid 13 that is exposed at the end of the shielded electric wire 10.

Next, as shown in FIG. 8, the end portion of the braid 13 is folded back from the front end edge of the inner sleeve 6 to the outside of the inner sleeve 6 to form a folded back portion 13a. A braided end 13b of the folded back portion 13a reaches the end portion of the sheath 14.

Thereafter, a part of the metal foil 12 is cut off up to the folded back portion of the braid 13, and the twisted pair electric wires 11 are untwisted. Then, the inner terminal 15 is crimped and connected to the core wire 11a that is exposed from the insulating sheath 11b of the end of each electric wire in the twisted pair electric wires 11.

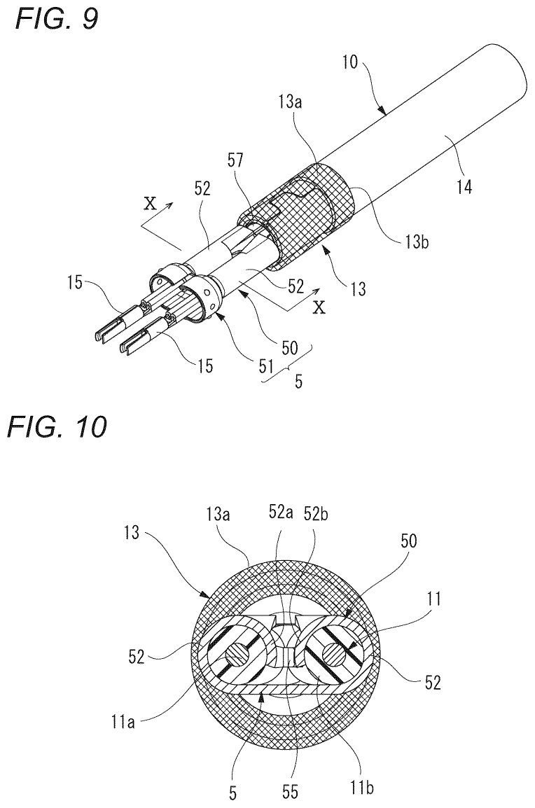

Next, as shown in FIG. 9, the inner terminal 15 is inserted through the matching component 5.

As shown in FIG. 10, each electric wire of the twisted pair electric wires 11 accommodated in the accommodating portion 52 of the transmission characteristic ensuring portion 50 can reduce the gap between each electric wire and the inner peripheral wall of the accommodating portion 52. Therefore, there is no adverse influence such as deterioration of the transmission characteristic of the electric wire.

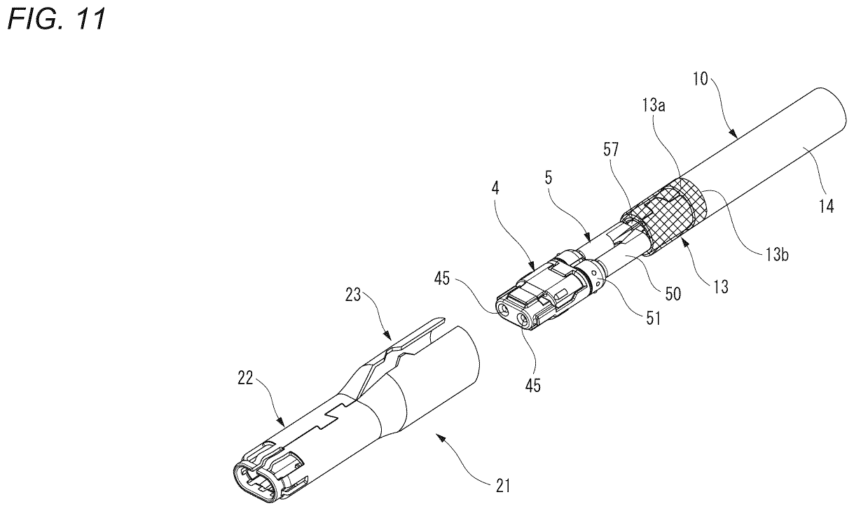

Next, as shown in FIG. 11, the inner terminal 15 through which the matching component 5 is inserted is accommodated in the inner terminal accommodating portion 45 of the inner housing 4, and the housing connection portion 51 of the matching component 5 is externally fitted to the rear end portion 43 of the inner housing 4. Then, the part of the insulating sheath 11b at the ends of the twisted pair electric wires 11 that are untwisted is accommodated in the transmission characteristic ensuring portion 50 of the matching component 5.

Next, the end of the shielded electric wire 10 in which the inner terminal 15 is accommodated in the inner housing 4 is inserted into the outer terminal 21. Then, in a state in which the inner housing 4 is accommodated in the inner housing accommodating chamber 20 of the shield body 22, the crimping portion 23 is crimped along the outer peripheral shape of the inner sleeve 6, so that the outer terminal 21 is electrically connected to the folded back portion 13a of the braid 13. At this time, the crimping portion 23 of the outer terminal 21 covers the folded back portion 13a of the braid 13 up to the braided end 13b. The outer terminal 21 is also electrically connected to the housing connection portion 51 of the matching component 5.

Then, the inner module 2 shown in FIG. 1 is completed by crimping this outer terminal 21.

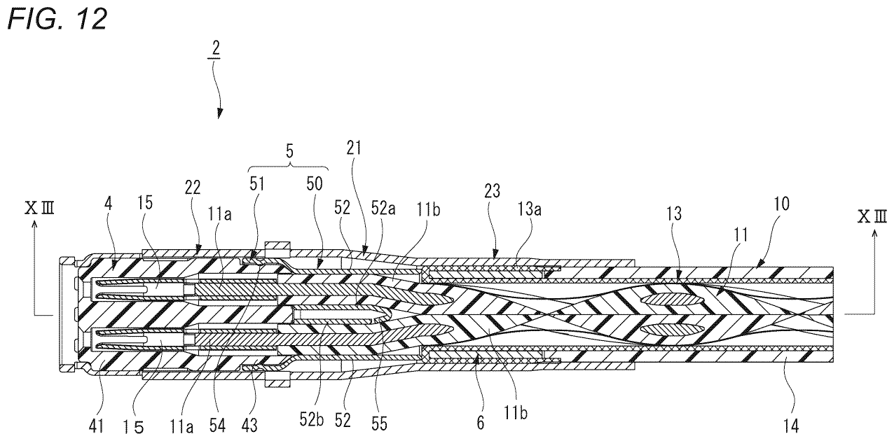

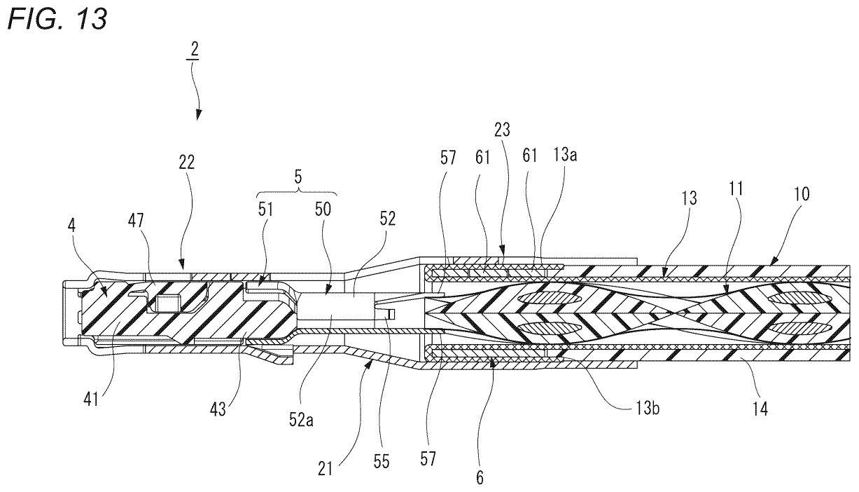

As described above, in the inner module 2 of the shielded connector 1 having the connector structure according to the present embodiment, as shown in FIGS. 11 and 12, the untwisted electric wires at the ends of the twisted pair electric wires 11 are accommodated in the transmission characteristic ensuring portion 50 of the matching component 5.

The transmission characteristic ensuring portion 50 includes the pair of hollow resilient accommodating portions 52 and 52, and can individually accommodate each of the untwisted electric wires at the ends of the twisted pair electric wires 11.

Since the accommodating portion 52 can be deformed along each electric wire of the twisted pair electric wires 11, it is possible to reduce the gap between each electric wire and the inner peripheral wall of the accommodating portion 52. Therefore, there is no adverse influence such as deterioration of the transmission characteristic of the electric wire. Further, the gap between each electric wire and the inner peripheral wall of the accommodating portion 52 is small, so that the electric wire is less likely to be damaged.

Therefore, according to the inner module 2 of the shielded connector 1 having the connector structure in the first embodiment, it is possible to easily improve the transmission characteristic in the shielded connector 1 using the twisted pair electric wires 11.

In the inner module 2 having the connector structure according to the first embodiment, the matching component 5 is press-molded to include the housing connection portion 51 on the distal end side into which the terminal insertion side end portion 43 of the inner housing 4 is press-fitted and the pitch converting portion 56 on the rear end side through which the end portions of the twisted pair electric wires 11 are inserted.

Therefore, the matching component 5 can smoothly convert the pair wire pitch in the twisted pair electric wire 11 to the housing pitch that is the interval between the pair of inner terminal accommodating portions 45 and 45 in the inner housing 4. The matching component 5 is easily connected to the terminal insertion side end portion 43 of the inner housing 4.

The housing connection portion 51 of the matching component 5 includes the inner protrusion 54 that protrudes toward the inner peripheral surface and the outer protrusion 53 that protrudes toward the outer peripheral surface.

Therefore, the housing connection portion 51 has a loose mechanical locking function for the rear end portion 43 of the inner housing 4, and functions as an electrical connection between the matching component 5 and the outer terminal 21.

The pitch converting portion 56 is provided with the branching guide portion 55 that branches the end portions of the twisted pair electric wires 11 when the inner terminals 15 that are connected to the end portions of the twisted pair electric wires 11 are inserted.

Therefore, each of the end portions of the twisted pair electric wires 11 is inserted through a respective one of the pair of accommodating portions 52 and 52 in the transmission characteristic ensuring portion 50, and the pair wire pitch of the twisted pair electric wires 11 is smoothly converted to the housing pitch.

### Second Embodiment

Next, an inner module 2A having a connector structure according to a second embodiment of the present disclosure will be described. The inner module 2A according to the second embodiment is different from that in the first embodiment described above in that the matching component and the outer terminal are different. Therefore, the same components as those in the first embodiment described above are denoted by the same reference signs, and the description thereof is omitted.

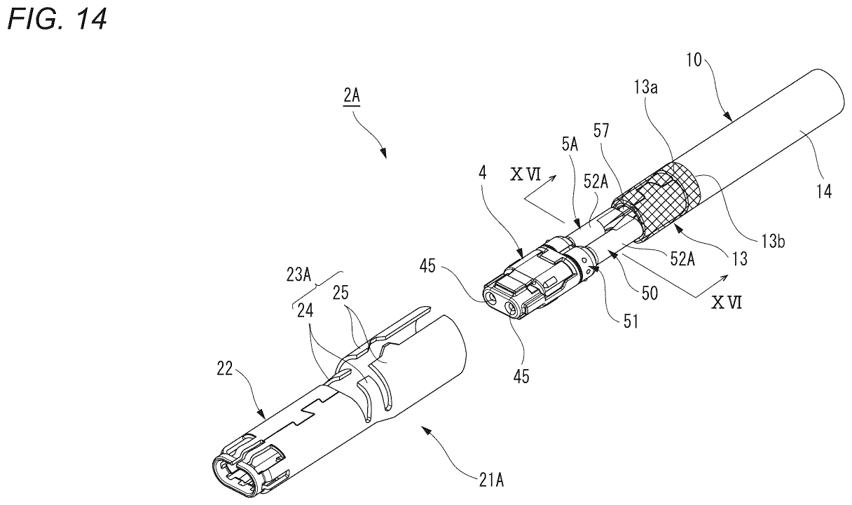

As shown in FIG. 14, an inner module 2A according to the second embodiment of the present disclosure includes the shielded electric wire 10, the inner terminal 15, the inner housing 4, a matching component 5A, the inner sleeve 6, and an outer terminal 21A.

As shown in FIGS. 14 to 17, the matching component 5A according to the second embodiment is made of metal and is formed into a substantially elliptical cylindrical shape, and the transmission characteristic ensuring portion 50 includes a pair of hollow resilient accommodating portions 52A and 52A and can individually accommodate each of the untwisted electric wires at the ends of the twisted pair electric wires 11. The accommodating portion 52A is press-molded so as to inwardly roll both side edge portions 52a and 52b of the matching component 5A along the electric wire insertion direction, thereby defining a hollow space having a circular cross section.

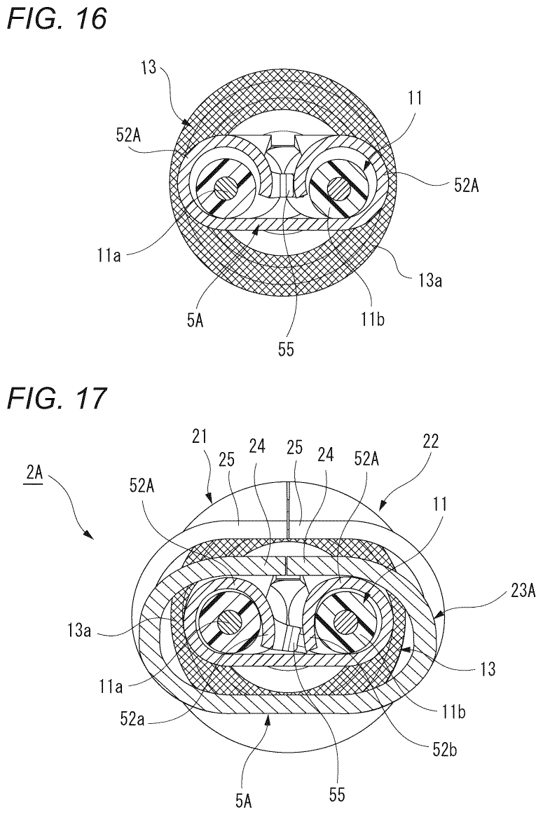

As shown in FIG. 16, the accommodating portion 52A has an inner diameter larger than the diameter of each electric wire of the twisted pair electric wires 11, and is set to a dimension that allows the inner terminal 15 larger than the inner terminal 15 according to the first embodiment to be inserted therethrough.

That is, the accommodating portion 52A can insert the inner terminal 15 larger than the diameter of each electric wire of the twisted pair electric wires 11.

The outer terminal 21A according to the second embodiment is made of metal having conductivity, and includes the shield body 22 that is formed into a substantially elliptical cylindrical shape, and a crimping portion 23A that increases in diameter from the rear end of the shield body 22 and that extends into a C-shaped cross section. The crimping portion 23A having a C-shaped cross section includes a pair of crimping pieces 24 and 24 serving as pressing portions for crimping the accommodating portion 52A of the matching component 5A, and a crimping portion 25 that is crimped to the outer peripheral side of the inner sleeve 6 so as to be electrically connected to the end portion of the braid 13 folded back and placed over the outer peripheral side of the inner sleeve 6.

The crimping portion 25 having a C-shaped cross section is crimped into a cylindrical shape along the outer peripheral shape of the inner sleeve 6 so as to be electrically connected to the end portion of the braid 13 that is folded back and placed over the outer peripheral side of the inner sleeve 6.

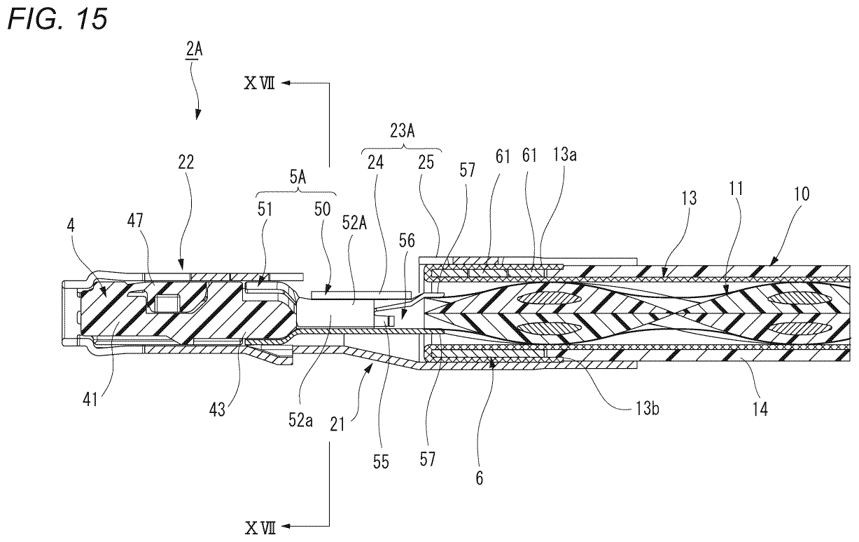

As shown in FIGS. 15 and 17, the pair of crimping pieces 24 and 24 press the accommodating portion 52A of the matching component 5A from above, thereby crimping the accommodating portion 52A such that the inner diameter of the accommodating portion 52A is reduced until the electrical wires come into contact with the accommodating portion 52A or there is a slight gap therebetween.

Therefore, according to the inner module 2A in the second embodiment of the present disclosure, even when the inner terminal 15 is larger than the diameter of each electric wire of the twisted pair electric wires 11, the inner terminal 15 can be smoothly inserted through the accommodating portion 52A of the matching component 5A.

Then, after the outer terminal 21A is assembled, the inner diameter of the accommodating portion 52A is reduced by the pair of crimping pieces 24 and 24 of the outer terminal 21A until the electrical wires come into contact with the accommodating portion 52A or there is a slight gap therebetween. Therefore, the transmission characteristic of the inner module 2A can be easily improved.

Insertion portions 57 protrude from the rear end of the accommodating portion 52A in the matching component 5A according to the second embodiment, and are inserted between the braid 13 that is folded back and placed over the outer peripheral side of the inner sleeve 6 and the twisted pair electric wires 11. The insertion portions 57 protrude from the upper portion and the lower portion of the rear end edge of the accommodating portion 52A.

Then, after the inner module 2A is assembled, the insertion portion 57 of the matching component 5A covers the gap that is generated between the folded back portion of the braid 13 and the rear end of the accommodating portion 52A, so that the transmission characteristic of the inner module 2A can be further improved.

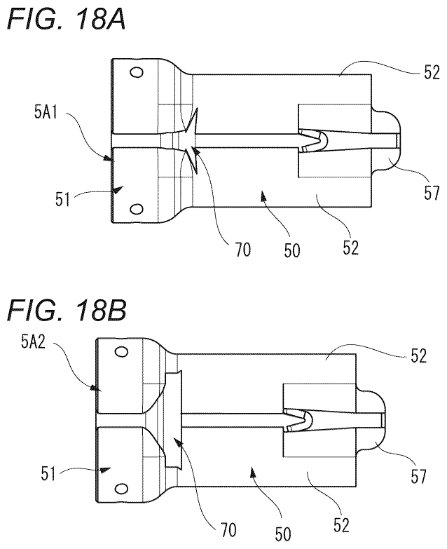

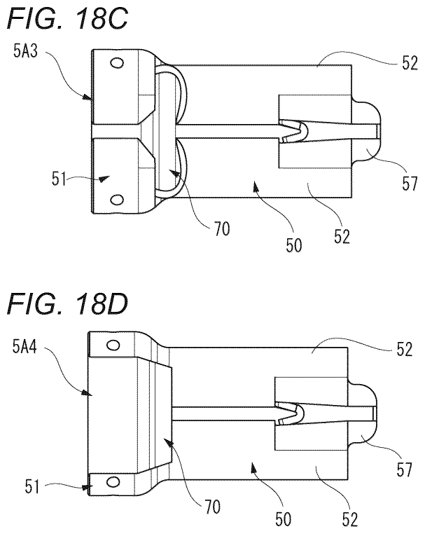

FIGS. 18A to 18D are plan views showing a modification of the matching component.

When the matching component 5A is press-molded, it is difficult to give the desired shape to the portion between the housing connection portion 51 and the transmission characteristic ensuring portion 50, and a hole may be formed.

Therefore, it is conceivable to remove, in various shapes, a portion 70 between the housing connection portion 51 and the transmission characteristic ensuring portion 50 having the hole. That is, by removing the portion 70 between the housing connection portion 51 and the transmission characteristic ensuring portion 50 having the hole without degrading the transmission characteristic, it is possible to have various shapes, such as matching components 5A1 to 5A4 according to the modifications shown in FIGS. 18A to 18D.

### Third Embodiment

Next, an inner module 2B having a connector structure according to a third embodiment of the present disclosure will be described. The inner module 2B according to the third embodiment is different from that in the first embodiment described above in that the matching component is different. Therefore, the same components as those in the first embodiment described above are denoted by the same reference signs, and the description thereof is omitted.

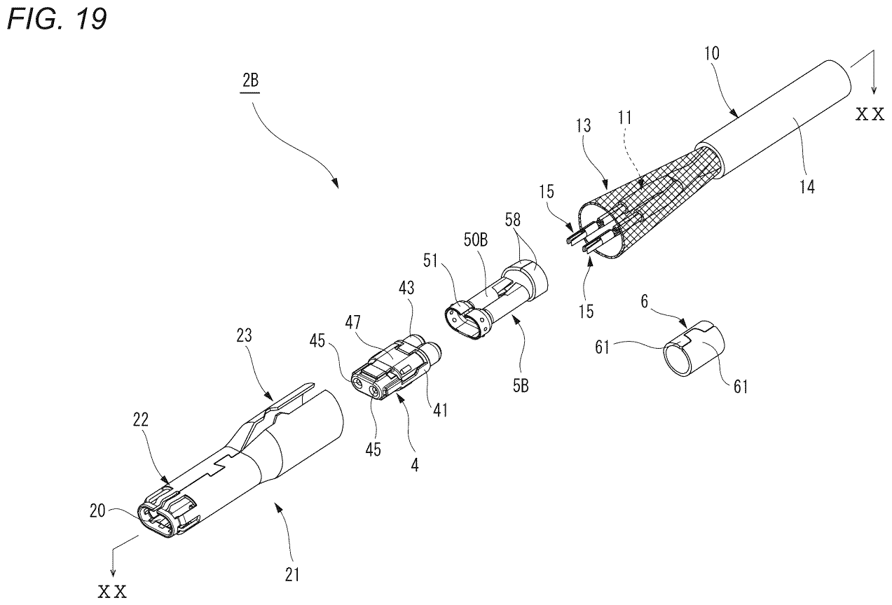

As shown in FIG. 19, an inner module 2B according to the third embodiment of the present disclosure includes the shielded electric wire 10, the inner terminal 15, the inner housing 4, a matching component 5B, the inner sleeve 6, and the outer terminal 21.

As shown in FIGS. 19 to 21, the matching component 5B according to the third embodiment is made of metal and is formed into a substantially elliptical cylindrical shape. The transmission characteristic ensuring portion 50B includes the pair of hollow resilient accommodating portions 52 and 52 and a cable connection crimping portion 58 that is provided on the rear end side of the accommodating portion 52, and can individually accommodate each of the untwisted electric wires at the ends of the twisted pair electric wires 11.

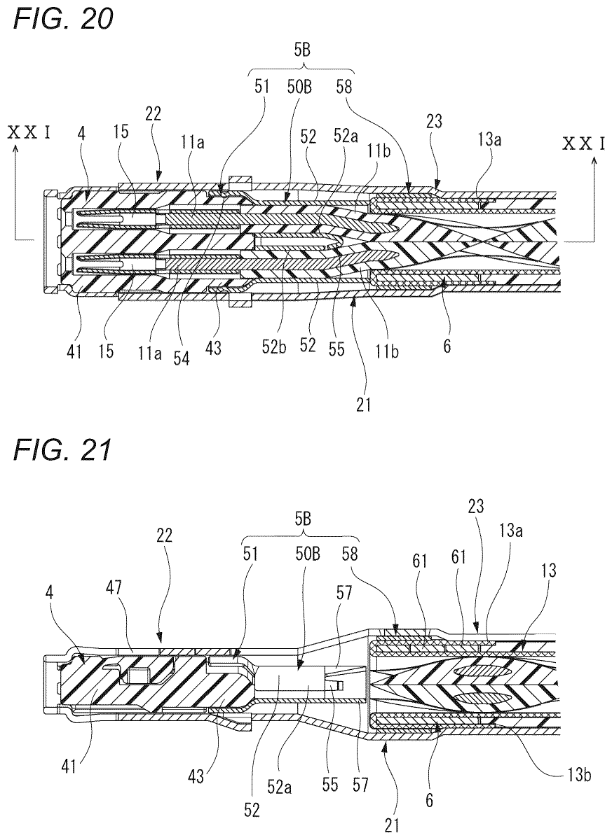

As shown in FIGS. 20 and 21, the cable connection crimping portion 58 is crimped

to the outside of the folded back portion 13a of the braid 13 that is folded back and placed over the outer peripheral side of the inner sleeve 6.

Therefore, the matching component 5B and the braid 13 are securely connected, and the positional relationship between the matching component 5B and the shielded electric wire 10 is fixed, thereby preventing variations in the transmission characteristic and contributing to the stability.

Therefore, the inner module 2B according to the third embodiment can stabilize the transmission characteristic.

### Fourth Embodiment

Next, an inner module 2C having a connector structure according to a fourth embodiment of the present disclosure will be described. The inner module 2C according to the fourth embodiment is different from that in the first embodiment described above in that the matching component is different. Therefore, the same components as those in the first embodiment described above are denoted by the same reference signs, and the description thereof is omitted.

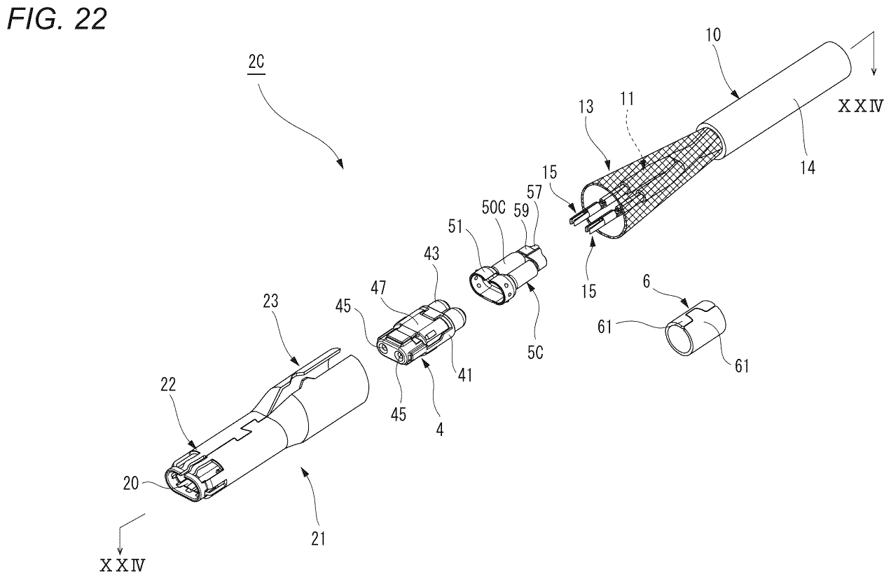

As shown in FIG. 22, the inner module 2C according to the fourth embodiment of the present disclosure includes the shielded electric wire 10, the inner terminal 15, the inner housing 4, a matching component 5C, the inner sleeve 6, and the outer terminal 21.

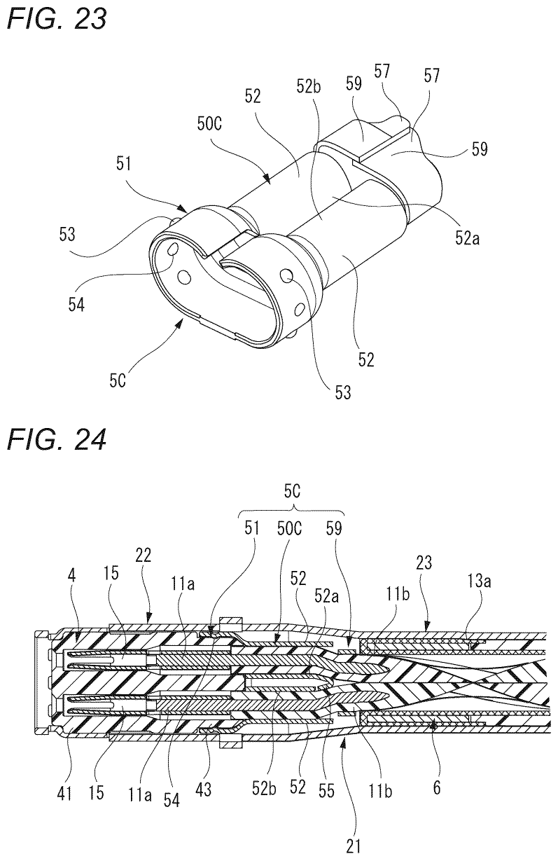

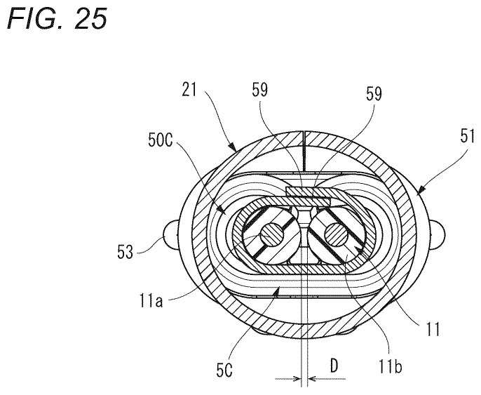

As shown in FIGS. 23 to 25, the matching component 5C according to the fourth embodiment is made of metal and is formed into a substantially elliptical cylindrical shape. The transmission characteristic ensuring portion 50C includes the pair of hollow resilient accommodating portions 52 and 52 and an electric wire crimping portion 59 that is provided on the rear end side of the accommodating portion 52, and can individually accommodate each of the untwisted electric wires at the ends of the twisted pair electric wires 11.

The electric wire crimping portion 59 includes a pair of resilient crimping pieces. As shown in FIG. 24, the electric wire crimping portion 59 covers in an overlapping manner the twisted pair electric wires 11 that are located between the folded back portion of the braid 13 and the rear end of the accommodating portion 52, and is elastically deformable in the electric wire radial direction. That is, since the electric wire crimping portion 59 can be deformed along the twisted pair electric wires 11, it is possible to reduce the gap between the twisted pair electric wires 11 and the electric wire crimping portion 59. Therefore, there is no adverse influence such as deterioration of the transmission characteristic of the electric wire.

Therefore, the electric wire crimping portion 59 covers the twisted pair electric wires 11 that are located between the folded back portion of the braid 13 and the rear end of the accommodating portion 52 so as to be elastically deformable in the electric wire radial direction, so that it is possible to reduce the interval length of the pair of untwisted electric wires at the ends of the twisted pair electric wires 11 and the gap between the electric wires. As a result, it is possible to prevent deterioration of the transmission characteristic of the twisted pair electric wires 11 that are located between the folded back portion of the braid 13 and the rear end of the accommodating portion 52.

Therefore, the inner module 2C according to the fourth embodiment can further improve the transmission characteristic.

The present disclosure is not limited to the embodiments described above, and can be appropriately modified, improved, and the like. In addition, the materials, shapes, sizes, numbers, arrangement positions, and the like of the components in the embodiments described above are freely selected and are not limited as long as the present disclosure can be implemented.

Here, the features of the connector structure according to the present disclosure described above are briefly summarized and listed in the following [1] to [8]. [1] A connector structure including:
a cable (a shielded electric wire 10) in which a braid (13) surrounding a twisted pair electric wire (11) is covered with a sheath (14);
an inner sleeve (6) that is placed over an outer peripheral side of the braid (13) exposed from an end portion of the sheath (14);
a pair of inner terminals (15, 15) that are electrically connected to core wires (11a) of the twisted pair electric wire (11) exposed from the end portion of the sheath (14); an inner housing (4) in which the inner terminals (15) are each accommodated in a respective one of a pair of inner terminal accommodating portions (45, 45);
a matching component (5) in which a pair of hollow accommodating portions (52) configured to accommodate end portions of the twisted pair electric wire (11) connected to the inner terminals (15) in a predetermined arrangement form are elastically deformable in an electric wire radial direction of the twisted pair electric wire (11); and
an outer terminal (21) including a shield body (22) configured to cover an outer periphery of the inner housing (4), and a crimping portion (23) that extends from the shield body (22) and that is crimped to an outer peripheral side of the inner sleeve (6) so as to be electrically connected to an end portion (a folded back portion 13a) of the braid (13) folded back and placed over the outer peripheral side of the inner sleeve (6).

According to the connector structure described in the above [1], the untwisted electric wires at the ends of the twisted pair electric wires (11) are accommodated in the hollow accommodating portions (52) of the matching component (5).

The pair of hollow resilient accommodating portions 52 and 52 can individually accommodate each of the untwisted electric wires at the ends of the twisted pair electric wires (11).

Since the accommodating portion (52) can be deformed along each electric wire of the twisted pair electric wires (11), it is possible to reduce the gap between each electric wire and the inner peripheral wall of the accommodating portion (52). Therefore, there is no adverse influence such as deterioration of the transmission characteristic of the electric wire.

[2] The connector structure according to the above [1],
in which the matching component (5) is press-molded to include a housing connection portion (51) on a distal end side into which a terminal insertion side end portion (43) of the inner housing (4) is press-fitted and a pitch converting portion (56) on a rear end side through which the end portions of the twisted pair electric wire (11) are inserted.

According to the connector structure described in the above [2], the matching component (5) can smoothly convert the pair wire pitch in the twisted pair electric wire (11) to the housing pitch that is the interval between the pair of inner terminal accommodating portions (45, 45) in the inner housing (4). The matching component (5) is easily connected to the terminal insertion side end portion (43) of the inner housing (4).

[3] The connector structure according to the above [2],
in which the housing connection portion (51) includes an inner protrusion (54) that protrudes toward an inner peripheral surface and an outer protrusion (53) that protrudes toward an outer peripheral surface.

According to the connector structure described in the above [3], the housing connection portion (51) has a loose mechanical locking function for the rear end portion 43 of the inner housing (4), and functions as an electrical connection between the matching component (5) and the outer terminal (21).

[4] The connector structure according to the above [2],
in which the pitch converting portion (56) is provided with a branching guide portion (55) configured to branch the end portions of the twisted pair electric wire (11) when the inner terminals (15) that are connected to the end portions of the twisted pair electric wires (11) are inserted.

According to the connector structure described in the above [4], each of the end portions of the twisted pair electric wires 11 is inserted through a respective one of the pair of accommodating portions (52, 52), and the pair wire pitch of the twisted pair electric wires 11 is smoothly converted to the housing pitch.

[5] The connector structure according to the above [1],
in which an insertion portion (57) protrudes from a rear end of the accommodating portion (52A), and is inserted between the braid (13) that is folded back and placed over the outer peripheral side of the inner sleeve (6) and the twisted pair electric wire (11).

According to the connector structure described in the above [5], after the inner module 2A is assembled, the insertion portion (57) of the matching component (5A) covers the gap that is generated between the folded back portion of the braid (13) and the rear end of the accommodating portion (52A), so that the transmission characteristic of the inner module (2A) can be further improved.

[6] The connector structure according to the above [1],
in which a cable connection crimping portion (58) that is crimped to an outside of the braid (13) folded back and placed over the outer peripheral side of the inner sleeve (6) is provided on a rear end side of the accommodating portion (52).

According to the connector structure described in the above [6], the matching component (5B) and the braid (13) are securely connected, and the positional relationship between the matching component (5B) and the shielded electric wire (10) is fixed, thereby preventing variations in the transmission characteristic and contributing to the stability. Therefore, the inner module 2B can stabilize the transmission characteristic.

[7] The connector structure according to the above [1],
in which an electric wire crimping portion (59) configured to cover in an overlapping manner the twisted pair electric wire (11) and to elastically deform in an electric wire radial direction is provided on a rear end side of the accommodating portion (52).

According to the connector structure described in the above [7], the electric wire crimping portion (59) covers the twisted pair electric wires (11) that are located between the folded back portion of the braid (13) and the rear end of the accommodating portion (52) so as to be elastically deformable in the electric wire radial direction, so that it is possible to reduce the interval length of the pair of untwisted electric wires at the ends of the twisted pair electric wires (11) and the gap between the electric wires. As a result, it is possible to prevent deterioration of the transmission characteristic of the twisted pair electric wires (11) that are located between the folded back portion of the braid (13) and the rear end of the accommodating portion (52). Therefore, the inner module (2C) can further improve the transmission characteristic.

[8] The connector structure according to any one of the above [1] to [7],
in which the outer terminal (21A) includes a pressing portion (a pair of crimping pieces 24 and 24) configured to crimp the accommodating portion (52A) in a diameter reduction direction.

According to the connector structure described in the above [8], even when the inner terminal (15) is larger than the diameter of each electric wire of the twisted pair electric wires (11), the inner terminal (15) can be smoothly inserted through the accommodating portion (52A) of the matching component (5A).

Then, after the outer terminal (21A) is assembled, the inner diameter of the accommodating portion (52A) is reduced by the pressing portion (the pair of crimping pieces 24 and 24) of the outer terminal (21A) until the electrical wires come into contact with the accommodating portion (52A) or there is a slight gap therebetween. Therefore, the transmission characteristic of the inner module (2A) can be easily improved.

What is claimed is:

1. A connector structure comprising:
a cable in which a braid surrounding a twisted pair electric wire is covered with a sheath;
an inner sleeve that is placed over an outer peripheral side of the braid exposed from an end portion of the sheath;
a pair of inner terminals that are electrically connected to core wires of the twisted pair electric wire exposed from the end portion of the sheath;
an inner housing in which the inner terminals are each accommodated in a respective one of a pair of inner terminal accommodating portions;
a matching component in which a pair of hollow accommodating portions configured to accommodate end portions of the twisted pair electric wire connected to the inner terminals in a predetermined arrangement form are elastically deformable in an electric wire radial direction of the twisted pair electric wire; and
an outer terminal including a shield body configured to cover an outer periphery of the inner housing, and a crimping portion that extends from the shield body and that is crimped to an outer peripheral side of the inner sleeve so as to be electrically connected to an end portion of the braid folded back and placed over the outer peripheral side of the inner sleeve.

2. The connector structure according to claim 1,
wherein the matching component is press-molded to include a housing connection portion on a distal end side into which a terminal insertion side end portion of the inner housing is press-fitted and a pitch converting portion on a rear end side through which the end portions of the twisted pair electric wire are inserted.

3. The connector structure according to claim 2,
wherein the housing connection portion includes an inner protrusion that protrudes toward an inner peripheral surface and an outer protrusion that protrudes toward an outer peripheral surface.

4. The connector structure according to claim 2,
wherein the pitch converting portion is provided with a branching guide portion configured to branch the end portions of the twisted pair electric wire when the inner terminals that are connected to the end portions of the twisted pair electric wires are inserted.

5. The connector structure according to claim 1,
wherein an insertion portion protrudes from a rear end of the accommodating portion, and is inserted between the braid that is folded back and placed over the outer peripheral side of the inner sleeve and the twisted pair electric wire.

6. The connector structure according to claim 1,
wherein a cable connection crimping portion that is crimped to an outside of the braid folded back and placed over the outer peripheral side of the inner sleeve is provided on a rear end side of the accommodating portion.

7. The connector structure according to claim 1,
wherein an electric wire crimping portion configured to cover in an overlapping manner the twisted pair electric wire and to elastically deform in an electric wire radial direction is provided on a rear end side of the accommodating portion.

8. The connector structure according to claim 1,
wherein the outer terminal includes a pressing portion configured to crimp the accommodating portion in a diameter reduction direction.
